(19) United States
(12) Patent Application Publication
(10) Pub. No.: US 2012/0313585 A1
(43) Pub. Date: Dec. 13, 2012

(54) Device for lithium ion battery storage and transportation

(76) Inventor: Frank Pereira, San Rafael, CA (US)

(21) Appl. No.: 13/385,166

(22) Filed: Feb. 6, 2012

Related U.S. Application Data
(60) Provisional application No. 61/462,699, filed on Feb. 7, 2011.

(51) Int. Cl. H01M 2/00; H02J 7/00

(52) U.S. Cl. 320/128; 429/48

(57) ABSTRACT

The present invention generally relates to the area of energy storage. It more specifically relates to a device that increases the safety characteristics of a lithium ion battery during storage and/or transportation. The device comprises a conducting element placed across the terminals of the battery.

This application claims priority under 35 U.S.C. §119(e) to U.S. provisional patent application Ser. No. 61/462,699, filed Feb. 7, 2011, which is hereby incorporated by reference.

### FIELD OF THE INVENTION

The present invention generally relates to the area of energy storage. It more specifically relates to a device that increases the safety characteristics of a lithium ion battery during storage and/or transportation.

### BACKGROUND OF THE INVENTION

Under certain circumstances, a lithium ion battery can fail catastrophically. Such failure can result in a fire and/or explosion. The risk associated with catastrophic failure was the primary impetus behind Department of Transportation regulations controlling the transportation of lithium ion batteries.

There is a need for new devices that can reduce safety risks provided by the storage and/or transportation of lithium ion batteries.

### BRIEF DESCRIPTION OF THE FIGURE

FIG. 1 shows a stylized version of one embodiment of a device according to the present invention connecting to the terminals of a lithium ion battery.

### SUMMARY OF THE INVENTION

The present invention generally relates to the area of energy storage. It more specifically relates to a device that increases the safety characteristics of a lithium ion battery during storage and/or transportation.

In a device aspect, the present invention provides a device for increasing the safety characteristics of a lithium battery during storage or transportation. The device comprises a conducting element placed across the terminals of the battery. The device does not result in more than a 30 percent decrease in the battery's energy density when it is connected to the battery for more than one day.

In a system aspect, the present invention provides a battery system for transport. The system comprises a battery and a device for increasing its safety characteristics. The device comprises a conducting element placed across the terminals of the battery. The device does not result in more than a 20 percent decrease in the battery's energy density when it is connected to the battery for more than 56 days. The battery has an anode comprising lithium titanate spinel, and the lithium titanate spinel has a surface area greater than 1 m²/g.

In a method aspect, the present invention provides a method of transporting a lithium ion battery. The method comprises the steps of: a) placing a device across the terminals of the battery, wherein the device comprises a conducting element, to form a battery system; and, b) placing the battery system in a space within an automobile, truck, ship, airplane or rail car and transporting it to another location. After the battery is transported, the device is removed and the battery is charged. The battery has not lost more than 20 percent of its energy density when the device has been connected to the terminals for at least 1 day.

### DETAILED DESCRIPTION OF THE INVENTION

The device of the present invention provides a way to visually determine whether a battery state-of-charge is below a threshold value from which a catastrophic event could occur. In one embodiment, the device is a conducting element that is placed across the positive and negative terminals of a battery, such that the terminals are electrically connected.

The conducting element may include any suitable material that can ensure the terminals are electrically connected. Nonlimiting examples of material classes that may be used include metals and metal alloys. A particularly suitable metal is copper.

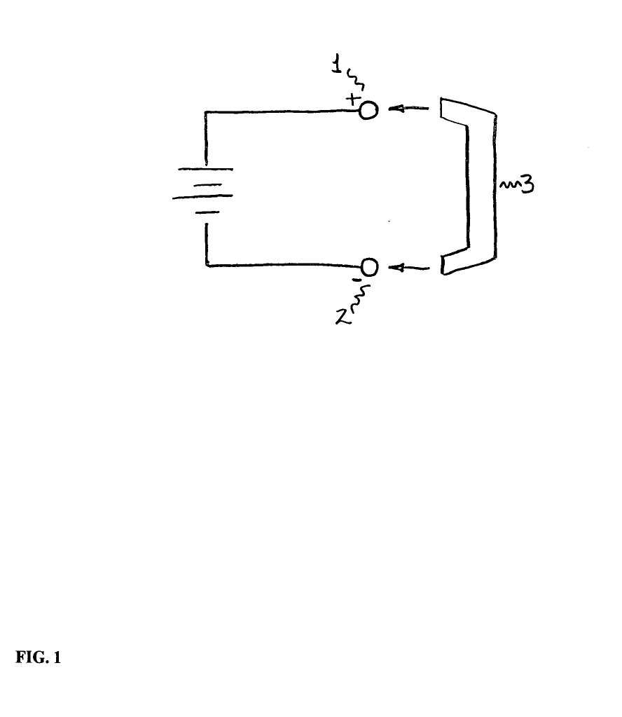

The conducting element may be of any suitable configuration. In one configuration, the element is of a bar-like shape that is attached to terminals through appropriate connectors (e.g., bolts attaching the bar to the battery housing such that the ends of the bar contact the terminals). In another configuration, the element is of a handle-like shape. When it is connected to a battery, one can use it to carry the battery as well as determine that it is below a threshold state-of-charge. FIG. 1 shows a stylized version of one embodiment of the element connecting the terminals of a lithium ion battery.

The conducting element optionally includes other features. The conducting element may be composed of a combination of a shunt resistor and related micro-control unit (MCU) circuitry that measures the battery's state-of-charge and shunts battery current through the resistor to bleed off state-of-charge to a pre-determined level. The conducting element may also be composed of an MCU that interfaces with battery state-of-charge control circuitry, which may include shunt resistors, to bleed off state-of-charge to a threshold state-of-charge.

The threshold state-of-charge is dependent upon the electrochemistry and is directly correlated between the highest safe voltage of the battery, equivalent to 100 percent state-of-charge, and the lowest safe voltage, equivalent to 0 percent state-of-charge. Lithium ion battery electrochemistry—and battery cell, module or pack configurations—will determine the appropriate voltage correlation between 0 percent and 100 percent state-of-charge.

After the conducting element has been connected to the terminals for 1 day, the battery retains greater than 70 percent of its energy density upon charging. Typically, the battery retains greater than 70 percent of its energy density after it has been connected for 7 days, 14 days, 21 days or 28 days. In certain cases the energy density is retained after it has been connected for 35, 42, 49, 56, 63, 70, 77, 84, 91, 98, 105, 112, 119, 126, 133, 140 or 147 days. In other cases the battery retains greater than 80 percent or 90 percent of its energy density.

The battery typically has an anode comprising lithium titanate (i.e., LiTi₄O₁₂) spinel. The lithium titanate usually has a BET surface area greater than 0.5 m²/g. In certain cases, it has a surface area greater than 1 m²/g, 3 m²/g, 5 m²/g, 7.5 m²/g, 10.0 m²/g, 12/5 m²/g, 15.0 m²/g, 17.5 m²/g, or 20.0 m²/g. In other cases, it has a surface area greater than 22.5 m²/g, 25.0 m²/g, 27.5 m²/g, 30.0 m²/g, 32.5 m²/g or 35.0 m²/g.

The lithium titanate particles are typically aggregates of primary particles. The aggregates are oftentimes roughly spherical in shape and hollow. Aggregates are usually in the micron diameter size range (e.g., 1 to 3 μM), while primary particles are typically in the nanometer diameter size range (e.g., 50 to 100 nM).

When the conducting element is connected to the battery, it decreases the probability of a catastrophic event by at least 50 percent. In certain cases, it decreases the probability by at least 55 percent, 60 percent, 65 percent, 70 percent, 75 percent, 80 percent, 85 percent, 90 percent or 95 percent. In other cases, the probability is decreased by at least 96 percent, 97 percent, 98 percent 99 percent, 99.5 percent, 99.6 percent, 99.7 percent, 99.8 percent or 99.9 percent.

The conducting element is removed from the battery before use. After removal, the battery is charged to a state-of-charge within it safe operating range.

1. A device for increasing the safety characteristics of a lithium ion battery during storage or transportation, wherein the device comprises a conducting element placed across the terminals of the battery, and wherein the device does not result in more than a 30 percent decrease in the battery's energy density when it is connected to the battery for more than 1 day.

2. The device according to claim 1, wherein the device comprises copper, and wherein it does not result in more than a 20 percent decrease in the battery's energy density when it is connected to the battery for more than 28 days.

3. The device according to claim 2, wherein it does not result in more than a 20 percent decrease in the battery's energy density when it is connected to the battery for more than 56 days.

4. The device according to claim 2, wherein the device further comprises a micro-control unit, at least one shunt resistor and terminal connection hardware, and wherein the device does not result in more than a 30 percent decrease in the battery's energy density when it is connected to the battery for more than 1 day.

5. The device according to claim 2, wherein the device further comprises a micro-control unit and connection circuitry to connect a battery contained micro-control unit, at least one shunt resistor and related circuitry, and wherein the device does not result in more than a 30 percent decrease in a battery's energy density when it is connected to the battery for more than 1 day.

6. A battery system for transport, wherein the system comprises a battery and a device for increasing its safety characteristics, and wherein the device comprises a conducting element placed across the terminals of the battery, and wherein the device does not result in more than a 20 percent decrease in the battery's energy density when it is connected to the battery for more than 56 days, and wherein the battery has an anode comprising lithium titanate spinel, and wherein the lithium titanate spinel has a surface area greater than 1 m²/g.

7. The battery system according to claim 6, wherein the device does not result in more than a 20 percent decrease in the battery's energy density when it is connected to the battery for more than 112 days, and wherein the lithium titanate spinel has a surface area greater than 10 m²/g, and wherein particle aggregates of the lithium titanate spinel are roughly spherical in shape and hollow.

8. The battery system according to claim 7, wherein the device comprises copper, and wherein the lithium titanate spinel has a surface area greater than 20 m²/g.

9. A method of transporting a lithium ion battery, wherein the method comprises the steps of:
a) placing a device across the terminals of the battery, wherein the device comprises a conducting element, to form a battery system;
b) placing the battery system in a space within an automobile, truck, ship, airplane or rail car and transporting it to another location
wherein after the battery transported the device is removed and the battery is charged, and wherein the battery has not lost more than 20 percent of its energy density when the device has been connected to the terminals for at least 1 day.

10. The method according to claim 9, wherein the method comprises the additional step of
connecting a device to a micro-control unit of the battery, wherein the unit provides for the battery to bleed state-of-charge to a threshold level.

11. The method according to claim 9, wherein the device comprises copper, and wherein the battery has not lost more than 20 percent of its energy density when the device has been connected to the terminals for at least 7 days.

12. The method according to claim 11, wherein the battery has an anode comprising lithium titanate spinel, and wherein the lithium titanate spinel has a surface area greater than 1 m²/g.

13. The method according to claim 12, wherein the battery has not lost more than 20 percent of its energy density when the device has been connected to the terminals for at least 14 days, and wherein the lithium titanate spinel has a surface area greater than 10 m²/g, and wherein particle aggregates of the lithium titanate spinel are roughly spherical in shape and hollow.

14. The method according to claim 10, wherein the device comprises copper, and wherein the battery has not lost more than 20 percent of its energy density when the device has been connected to the terminals for at least 7 days, and wherein the battery has an anode comprising lithium titanate spinel, and wherein the lithium titanate spinel has a surface area greater than 1 m²/g.
